(19) United States
(12) Patent Application Publication
(10) Pub. No.: US 2025/0369906 A1
(43) Pub. Date: Dec. 4, 2025

(54) SYSTEMS AND METHODS FOR TORCH AND GRIT TESTING MATERIAL SAMPLES UNDER SIMULATED CONDITIONS

(71) Applicant: UL LLC, Northbrook, IL (US)

(72) Inventors: Benjamin Joseph Gaudet, Chicago, IL (US); Michael Howard SaLee, Island Lake, IL (US)

(21) Appl. No.: 18/731,642

(22) Filed: Jun. 3, 2024

(51) Int. Cl. G01N 25/26; G01N 25/32; G01N 25/42; H01M 10/42

(52) U.S. Cl. CPC G01N 25/26; G01N 25/32; G01N 25/42; H01M 10/4285

(57) ABSTRACT

An apparatus for testing a sample includes a fixture releasably holding the sample during a test, a first mixer having a first chamber and a first channel, the first chamber mixing compressed air with abrasive particles to form a first mixture having a first predetermined mixing ratio, the first channel projecting the first mixture at a spot of the sample during the test, a second mixer having a second chamber, an ignitor and a second channel, the second chamber mixing an oxidizer and a fuel to form a combustible mixture with a second predetermined mixing ratio, the ignitor adjacent to an outlet of or protruding into the second chamber and controllably igniting the combustible mixture to create a flame, the second channel projecting the flame at the spot during the test, and a first temperature sensor measuring a surface temperature of an unexposed side of the sample during the test.

### TECHNICAL FIELD

The present description relates to testing material samples under simulated conditions, and more particularly to testing material samples under simulated battery thermal runaway conditions.

### BACKGROUND

In lithium-ion (Li-ion) cells, the movement of lithium ions produces electricity. The process of charge and discharge is normally accompanied by a small amount of heat.

In ideal conditions, the heat is able to dissipate from the cell. However, in thermal runaway, the Li-ion cell generates heat at a rate several times higher than the rate at which heat dissipates from the cell. The Li-ion cell reaches thermal runaway when its temperature rises uncontrollably at a high rate with maximum temperatures reaching greater than 300° C. accompanied by release of gas and/or electrolyte vapor, smoke or fire or a combination of all.

Faults in a Li-ion cell can result in a thermal runaway. These faults can be caused by internal failure or external conditions.

One example of such internal failure is an internal short circuit. In a Li-ion cell, the cathode and anode electrodes are physically separated by a separator. Defects in the cell that compromise the separator's integrity can cause an internal short circuit condition that can result in thermal runaway. This is especially likely in cells of poor quality.

External, off-nominal conditions can also cause thermal runaway. Examples of off-nominal conditions include:
Overcharge: can be due to incompatibility between cell and charger, or poorly designed battery management system (BMS)
Multiple over discharges followed by charge: discharging the cell or battery below the cell manufacturer-recommended lower voltage threshold multiple times, then charging the cell
External short circuit
High- and low-temperature environments

Materials used in the construction of Li-ion batteries, battery packs and battery-powered devices must be robust to ensure safety, longevity, and performance. Testing these materials is a critical step in ensuring such requirements. A key parameter in material selection is thermal and mechanical tolerance against a simulated thermal runaway condition. Thermal analysis can determine decomposition temperature, chemical composition, degree of oxidation, solvent composition, melting temperature, glass transition, and thermal stability.

As such, systems and methods for testing material samples under simulated Li-ion battery thermal runaway conditions are desired.

A prior art system is shown in FIG. 1, which is a cross-sectional view of an exemplary grit injection apparatus 100. The grit apparatus 100 include a mixing block 110 for mixing compressed air 130 with abrasive particles or grit 140. In embodiments, the mixing block 110 includes a tubular setup such as a Venturi tube 112 of varying diameters. As shown in FIG. 1, an inlet section 115 of the tube 112 and an outlet section 119 of the tube 112 have larger diameters than that of a middle section 117 of the tube 112. There is a port 122 reaching the middle section 117 of the tube 112 for passing the abrasive particles 140 into the tube 112.

In operations, a velocity of the compressed air 130 must increase as it passes through the constricted middle section 117 in accord with the principle of mass continuity, while its static pressure must decrease in accord with the principle of conservation of mechanical energy (Bernoulli's principle). Thus, any gain in kinetic energy a fluid may attain by its increased velocity through a constriction is balanced by a drop in pressure because of its loss in potential energy. The drop in pressure in the middle section 117 creates a negative pressure differential in the port 122 to pull in the abrasive particles 140. By adjusting the velocity of the compressed air 130, the negative pressure differential and thus the amount of abrasive particles pulled in can be adjusted. The abrasive particles 140 are then pulled through the port 122 and propelled through the outlet section 119 so that the abrasive particles 140 are shot or otherwise moved toward a sample 142, where the sample 142 may be a material sample being tested for its potential as a material for use in a battery, battery pack, or battery powered device. The abrasive particles 140 may also then be propelled through a torch 144, so that both flames from the torch and the abrasive particles 140 are projected at 146 onto the sample 142.

### SUMMARY

In some aspects, the techniques described herein relate to an apparatus for testing a material sample, the apparatus including: a fixture configured to releasably hold the material sample during a test; a first mixer having a first chamber and a first channel, the first chamber being configured to mix compressed air with abrasive particles to form a first mixture having a first predetermined ratio between the compressed air and the abrasive particles, the first channel being configured to project the first mixture at a predetermined spot of the material sample during the test; a second mixer having a second chamber, an ignitor and a second channel, the second chamber being configured to mix an oxidizer and a fuel to form a combustible mixture with a second predetermined ratio between the oxidizer and the fuel, the ignitor located adjacent to an outlet of or protruding into the second chamber and configured to controllably ignite the combustible mixture to create a flame, the second channel being configured to project the flame at the predetermined spot during the test; and a first temperature sensor configured to measure a surface temperature of a side of the material sample unexposed to the flame during the test.

In some aspects, the techniques described herein relate to an apparatus, further including a second temperature sensor configured to measure a temperature of the flame before and/or during the test.

In some aspects, the techniques described herein relate to an apparatus, further including a programmable logic controller configured to receive temperature measurements from the first and second temperature sensors and to control flow rates of the oxidizer and the fuel based at least in part on the temperature measurements.

In some aspects, the techniques described herein relate to an apparatus, further including a first mass flow controller controlled by the programmable logic controller to control the flow rate of the compressed air supplied to the first mixer during the test.

In some aspects, the techniques described herein relate to an apparatus, further including a second mass flow controller controlled by the programmable logic controller to control the flow rate of the fuel supplied to the second mixer during the test.

In some aspects, the techniques described herein relate to an apparatus, further including a third mass flow controller controlled by the programmable logic controller to control a flow rate of the oxidizer supplied to the second mixer during the test.

In some aspects, the techniques described herein relate to an apparatus, wherein the first chamber includes a narrow passage and port leading to the narrow passage.

In some aspects, the techniques described herein relate to an apparatus, further including a container configured to hold a supply of the abrasive particles and controllably deliver the abrasive particles to the port due to gravity and/or negative pressure differential.

In some aspects, the techniques described herein relate to an apparatus, further including an actuating pinch valve connected between the container and the port and controlled by the programmable logic controller for regulating an amount of abrasive particles flowed to the port during the test.

In some aspects, the techniques described herein relate to an apparatus, further including a third temperature sensor configured to measure an ambient temperature behind the material sample unexposed to the flame, wherein the ambient temperature is provided to the programmable logic controller.

In some aspects, the techniques described herein relate to an apparatus, further including a heat shield motioned between a first position shielding the material sample from the flame and a second position exposing the material sample to the flame, wherein the motion of the heat shield is controlled by the programmable logic controller.

In some aspects, the techniques described herein relate to an apparatus, wherein the programmable logic controller is programmed to actuate the ignitor at a predetermined flow rate setpoint for the fuel.

In some aspects, the techniques described herein relate to an apparatus, wherein the first channel leads to or towards the second chamber to provide the first mixture to the second mixer.

In some aspects, the techniques described herein relate to an apparatus, further including a flame arrestor horizontally placed above the material sample to prevent the flame from reaching a space behind the material sample.

In some aspects, the techniques described herein relate to a system for testing a material sample, the system including: a fixture configured to releasably hold the material sample during a test; a first mixer having a first chamber and a first channel, the first chamber being configured to mix compressed air with abrasive particles to form a first mixture having a first predetermined ratio between the compressed air and the abrasive particles, the first channel being configured to project the first mixture at a predetermined spot of the material sample during the test; a second mixer having a second chamber, an ignitor and a second channel, the second chamber being configured to mix an oxidizer and a fuel to form a combustible mixture with a second predetermined ratio between the oxidizer and the fuel, the ignitor located adjacent to an outlet of or protruding into the second chamber and configured to controllably ignite the combustible mixture to create a flame, the second channel being configured to project the flame at the predetermined spot during the test; a first temperature sensor configured to measure a surface temperature of a side of the material sample unexposed to the flame during the test; a second temperature sensor configured to measure a temperature of the flame before and/or during the test; and a programmable logic controller configured to receive temperature measurements from the first and second temperature sensors and to regulate flow rates of the oxidizer and the fuel based at least in part on the temperature measurements.

In some aspects, the techniques described herein relate to a system, further including a first mass flow controller controlled by the programmable logic controller to control the flow rate of the compressed air supplied to the first mixer during the test.

In some aspects, the techniques described herein relate to a system, further including a second mass flow controller controlled by the programmable logic controller to control the flow rate of the fuel supplied to the second mixer during the test.

In some aspects, the techniques described herein relate to a system, further including a third mass flow controller controlled by the programmable logic controller to control a flow rate of the oxidizer supplied to the second mixer during the test.

In some aspects, the techniques described herein relate to a system, wherein the first channel leads to or towards the second chamber to provide the first mixture to the second mixer.

In some aspects, the techniques described herein relate to a method for testing a material sample, the method including: releasably holding the material sample by a fixture during a test; mixing compressed air with abrasive particles by a first mixer to form a first mixture having a first predetermined ratio between the compressed air and the abrasive particles; channeling the first mixture by a first channel of the first mixer to a predetermined spot of the material sample during the test; mixing an oxidizer and a fuel by a second mixer to form a combustible mixture having a second predetermined ratio between the oxidizer and the fuel; igniting the combustible mixture by an ignitor adjacent to an outlet of or protruding into the second mixer to create a flame; projecting the flame by a second channel of the second mixer to the predetermined spot during the test; and measuring a surface temperature of a side of the material sample unexposed to the flame by a temperature sensor during the test.

### BRIEF DESCRIPTION OF THE DRAWINGS

FIG. 1 is a cross-sectional view of an exemplary blast injecting grit apparatus.

FIG. 2 is a cross-sectional view of an exemplary flame producing torch apparatus.

FIG. 3A illustrates an exemplary torch-and-grit system for testing material samples under simulated conditions according to embodiments of the present disclosure.

FIG. 3B illustrates another exemplary torch-and-grit system for testing material samples under simulated conditions according to embodiments of the present disclosure.

FIG. 4 illustrates another exemplary torch-and-grit system for testing material samples under simulated conditions according to embodiments of the present disclosure.

FIG. 5 is a block diagram illustrating an exemplary programmable logic controller for controlling the presently disclosed grit-and-torch systems according to embodiments of the present disclosure.

FIG. 6 is a flowchart illustrating an exemplary process of testing a material sample under simulated conditions according to embodiments of the present disclosure.

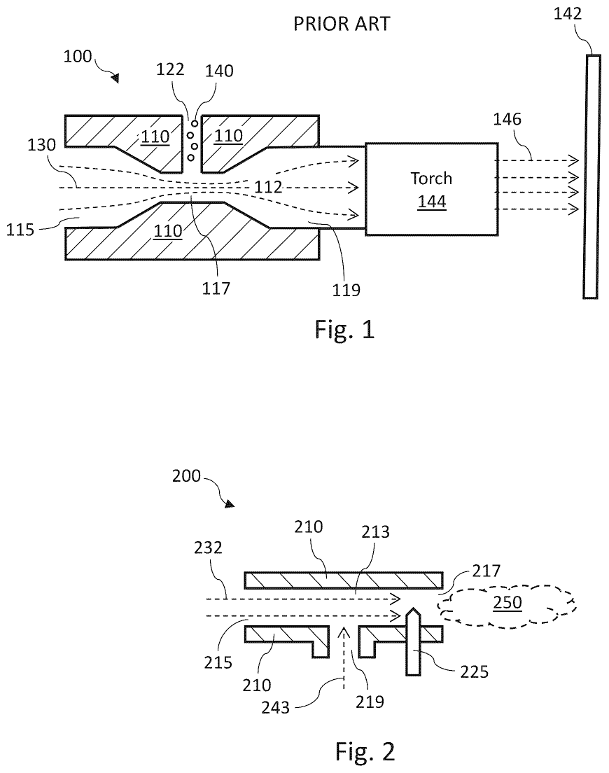

### DETAILED DESCRIPTION

The present disclosure describes systems and methods for testing material samples under simulated conditions.

The following description of example systems and methods is not intended to limit the scope of the description to the precise form or forms detailed herein. Instead, the following description is intended to be illustrative so that others may follow its teachings.

As described above, the grit apparatus 100 works as a mixer to form a mixture of the compressed air and the abrasive particles 140 so that the abrasive particles 140 are shot or otherwise moved toward the sample 142.

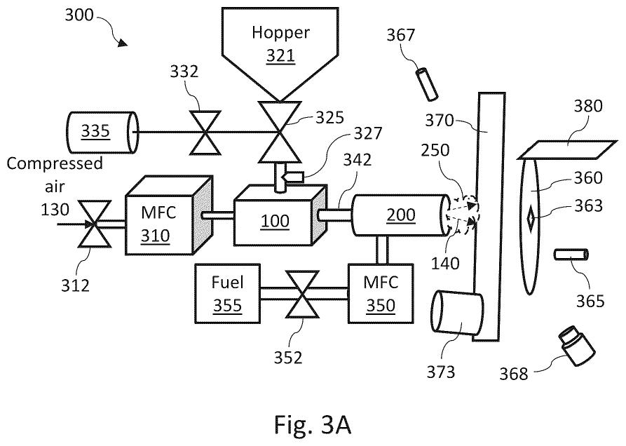

FIG. 2 is a cross-sectional view of an exemplary flame producing torch apparatus 200. The torch apparatus 200 includes a heat resisting body 210 forming a mixing chamber 213 with an oxidizer inlet 215, a flame outlet 217 and a fuel inlet 219 for premixing an oxidizer 232 and a fuel 243. The flame producing apparatus also includes an igniter 225 located adjacent to the outlet of or protruding into the mixing chamber 213 for controllably igniting the premixed oxidizer 232 and the fuel 243.

In operations, both the oxidizer 232 and the fuel 243 are supplied to the mixing chamber 213. Then the igniter 225 ignites the mixture of oxidizer 232 and the fuel 243 to produce a high temperature flame 250 through the flame outlet 217. In some embodiments, the oxidizer 232 may be air or oxygen; and the fuel 243 may be hydrogen, methane and/or propane.

As described above, the torch apparatus 200 works as a mixer and flame producer. The mixer forms a combustible mixture of the oxidizer and the fuel. The flame producer ignites the combustible mixture to create a flame at the flame outlet 217.

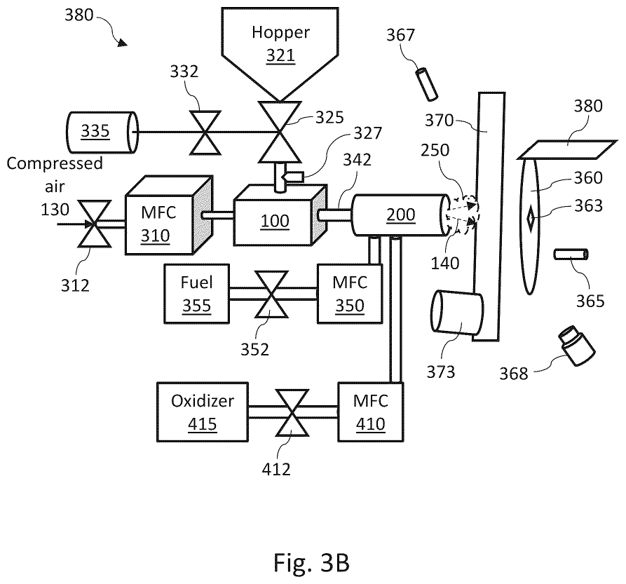

FIG. 3A illustrates an exemplary torch-and-grit system 300 for testing material samples under simulated conditions according to embodiments of the present disclosure. The torch-and-grit system 300 includes an abrasive particle hopper 321 as a container to supply the abrasive particles 140 to the grit apparatus 100 at the port 122 through a particle dispensing pinch valve 325. The compressed air 130 is supplied to the grit apparatus 100 through a mass flow controller (and pressure regulator) 310 to achieve a desired flow rate and pressure for the air. The flow of the compressed air in the grit apparatus 100 creates a negative pressure differential at the port 122 to suck in the abrasive particles 140 from the abrasive particle hopper 321 when the particle dispensing pinch valve 325 is open.

In embodiments, a pressure sensor 327 may be installed in a tube channeling the abrasive particles 140 to the port 122 of the grit apparatus 100 for detecting a pressure in the tube to make sure that a negative pressure differential at the port 122 is properly maintained during a test of a material sample and to monitor the integrity of the grit apparatus 100 over time. As an example, the pressure sensor 327 may be a vacuum transducer mounted in the tube connecting the port 122 and the particle dispensing pinch valve 325.

In embodiments, the flow of the compressed air 130 may be turned on and off with an automatically actuated air valve 312 which may serve as a safety shutoff valve.

In an embodiment, the particle dispensing pinch valve 325 may be an elastomer pinch valve which is opened and closed by application of air pressure or vacuum thereto. Within the pinch valve there may be additionally installed a flow restriction orifice or metering mechanism to refine the flow rate of abrasive particles through the pinch valve. Thus, the pinch valve 325 may be an actuating pinch valve with an interior abrasive particle flow control orifice or metering mechanism, where the pinch valve is connected between the container and the port and controlled by a programmable logic controller for regulating an amount of abrasive particles flowed to the port during a test. The application of the air pressure or vacuum may be controlled by an air valve 332 (for the grit apparatus 100) and a vacuum generator 335. Opening the particle dispensing pinch valve 325 exposes the abrasive particle hopper 321 to negative pressure differential and allows the abrasive particles 140 to flow into the compressed air flow path due to negative pressure differential and gravity. The particle dispensing pinch valve 325 provides a metering mechanism for controlling the amount of abrasive particles 140 entering the grit apparatus 100 which uses the compressed air 130 to create a pressurized flow of the abrasive particles 140 which are also called grit. In some embodiments, the particle dispensing pinch valve 325 shuts off the supply of the abrasive particles 140, while the delivery of the compressed air 130 continues. Consequently, the torch apparatus 200 is supplied only with compressed air, resulting in the flame 250 that is devoid of abrasive particles.

Referring again to FIG. 3A, the outlet section 119 of the grit apparatus 100 is connected to the torch apparatus 200 through a tube 342 to supply the mixture of air (as an oxidizer) and abrasive particles 140 to the torch apparatus 200. The fuel inlet 219 of the torch apparatus 200 is connected to fuel source 353 through a mass flow controller (MFC) 350. The MFC 350 regulates the fuel 355's flow rate into the torch device, thereby determining the flame 250's temperature. In some embodiments, a fuel-line valve 352 (e.g., a safety shutoff valve) is installed in line with the MFC 350 to shut off fuel supply to the torch apparatus 200 in an emergency.

Referring again to FIG. 3A, the flame outlet 217 of the torch apparatus 200 is directed to a material sample 360 under test. When the mixture of the compressed air 130, the abrasive particles 140 and the fuel 355 in the torch apparatus 200 is ignited, a flame with the abrasive particles 140 will be projected at a surface of the material sample 360. The material sample 360 is installed in a sample fixture (not shown) in front of the outlet of the torch apparatus 200. Then the grit-and-torch system 300 creates various test conditions for the material sample 360 by exposing the material sample 360 to the flame 250 and/or the pressurized flow of abrasive particles 140 for varying durations and at varying intensities. The term, “intensity” used herein, refers generally to a degree of exposure temperature and volume and pressure of the abrasive particles. The varying intensities is caused by varying the grit mass flow rate, compressed air flow rate and pressure, and flame temperature which is controlled by flow rates of the fuel and the oxidizer.

In embodiments, the material sample 360 may be monitored by temperature sensors. As shown in FIG. 3A, a surface temperature sensor 363 may be in direct contact with a side of the material sample 360 that is not exposed to the flame 250. An ambient temperature sensor 365 may be installed a distance behind the unexposed side of the material sample 360. A flame temperature sensor 367 may be installed a distance to the flame in front of the material sample 360. In addition, a video camera 368 may be used to monitor the material sample 360 during a test. The controls of the temperature sensors 363, 365 and 367 and the video camera 368 may be synchronized with the control and grit apparatus 100 and the torch apparatus 200. As such, ambient temperature, material surface temperature, flame temperature, or any combination thereof may be measured before, during, and/or after a test by the temperature sensors 363, 365 and 367. For example, such temperatures may be measured before a test begins to calibrate the system and/or ensure that the components are operating as desired or expected for a given test.

Referring again to FIG. 3A, to control the start and end of the exposure of the material sample 360 to the flame 250 and the abrasive particles 140, a non-combustible flame shield 370 is installed in front of the material sample 360 to shield it from the flame 250. The shield 370 can be automatically moved out of the way to allow the material sample 360 to be exposed to the flame 250 and/or the pressurized flow of abrasive particles 140. In embodiments, the flame shield 370 is moved by a double acting pneumatic cylinder which include solenoids controlled by a programmable logic controller (not shown). After a testing of the material sample 360, a user can retract the flame shield back into the shielding place via a human machine interface (HMI). In other embodiments, the flame shield can be automatically controlled by a programmable logic controller.

In embodiments, a horizontal flame arrestor 380 may be installed flush with a top of the unexposed side of the material sample 360 to avoid unexposed-side ignition of the material sample 360. The flame arrestor 380 prevents flaming on the material sample 360 evolving on the unexposed side until a time when a hole is formed in the material sample 360. In various embodiments, flame arrestor material may be located on any side of the material sample 360, including completely surrounding the thin edge of the material sample 360 around all sides, located on a back side of the material sample 360 (e.g., on the unexposed side of the material sample 360), on a left edge of the material sample 360 (e.g., toward the foreground of the view in FIG. 3A), on a right edge of the material sample 360 (e.g., toward a background of the view in FIG. 3A), on a bottom edge of the material sample 360 opposite the flame arrestor 380 shown in FIG. 3A, at the location at the top edge of the material sample 360 where the flame arrestor 380 is located, or any combination thereof.

FIG. 3B illustrates another exemplary torch-and-grit system 380 for testing material samples under simulated conditions according to embodiments of the present disclosure. The system 380 is similar to the system 300 of FIG. 3, except the torch 200 is separately supplied by its own supply of oxidizer 415 through a MFC 410 and controllable with a valve 412 (e.g., a safety shutoff valve), rather than using the compressed air 130 as an oxidizer as in the system 300 of FIG. 3B.

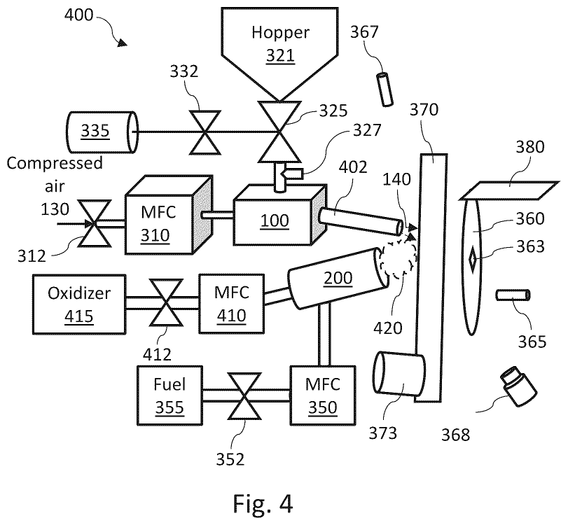

FIG. 4 illustrates another exemplary torch-and-grit system 400 for testing material samples under simulated conditions according to embodiments of the present disclosure. A difference between the torch-and-grit systems 300 and 400 is that the torch-and-grit system 400 employs separated grit apparatus 100 and torch apparatus 200. As shown in FIG. 4, the outlet of the grit apparatus 100 is connected to a tube 402 which is directed directly to the material sample 360. As a result, the pressurized flow of abrasive particles 140 created by the grit apparatus 100 are channeled directly at the material sample 360. In embodiments, when a simulated test condition does not require a blast of abrasive particles 140 at a material sample, the MFC 310 may shut off the supply of the compressed air 130 to the grit apparatus 100. In addition, the particle dispensing pinch valve 325 may shut off the supply of the abrasive particles 140 to the grit apparatus.

Referring again to FIG. 4, the torch apparatus 200 has its own supply of the oxidizer 415 through the MFC 410 and the valve 412 (e.g., a safety shutoff valve). An outlet of the torch apparatus 200 is directed to the material sample 360 at the same spot as the tube 402 of the grit apparatus 100 is directed to.

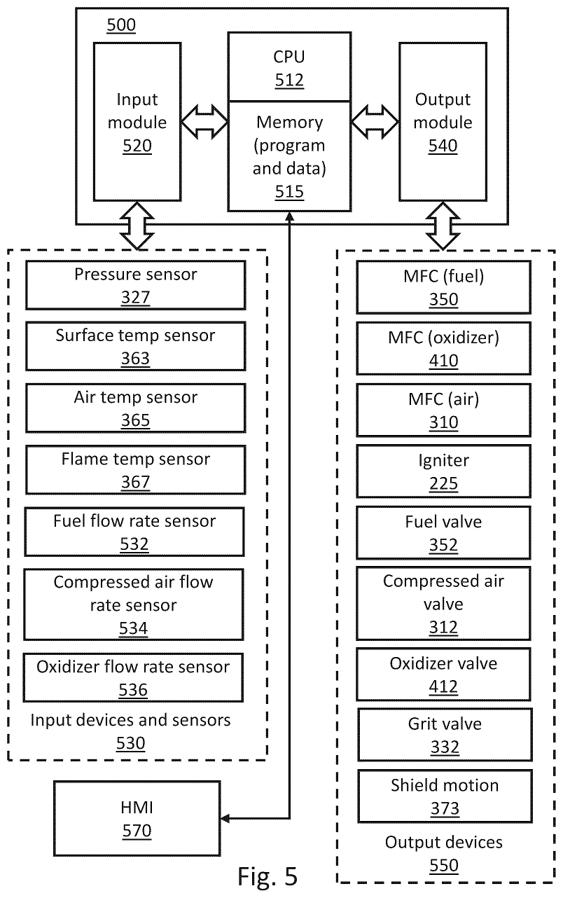

FIG. 5 is a block diagram illustrating an exemplary programmable logic controller (PLC) 500 for controlling the presently disclosed grit-and-torch system 300 or 400. The PLC 500 includes a central processing unit (CPU) 512 and an associated memory 515 for storing program instructions and data. The program instructions are loaded from a human-machine-interface (HMI) 570 which also provides a user with direct controls to the PLC 500 as well as displays of the states of the grit-and torch system 300 or 400. The PLC 500 data logs testing cycle count, valve positions, fuel flow, oxidizer flow, compressed air flow, and temperature measurements. This data is recorded every second or faster to coincide with the testing time. Every material sample 360 that is tested creates a new uniquely numbered data file. These files are then used in an automated client test report generation. Additionally, the PLC 500 performs a flame verification procedure to check the current average temperature of the flame 250 (FIGS. 3A and 3B) or 420 (FIG. 4) based on temperature measurements from a removable temperature sensor that can be placed in the flame 250 or 420. This flame temperature data is also logged by the PLC 500 for recording purposes.

Referring again to FIG. 5, the PLC 500 also includes an input module 520 and an output module 540 in communication with and controlled by the CPU 512. The input module 520 provides an interface for input devices and sensors 530. The output module 540 provides an interface to output devices 550.

In embodiments, the input devices and sensors 530 include the pressure sensor 327, the surface temperature sensor 363, the ambient temperature sensor 365, a flame temperature sensor 367, a fuel flow rate sensor 532, a compressed air flow rate sensor 534, and an oxidizer flow rate sensor 536. The pressure sensor 327 is used for measuring a pressure in the port 122 of the grit apparatus 100 to ensure a negative pressure differential is maintained therein during a test of a material sample. The surface temperature sensor 363 measures temperatures, over time, at a surface of a side of a material sample that is not exposed to the flame. Such measurements track temperature changes of the material sample under test. The ambient temperature sensor 365 measures air temperatures, over time, at a distance behind the exposed side of the material sample. The PLC 500 may use the measured ambient temperature to monitor the test environment. If the air temperature exceeds a predetermined threshold, the PLC 500 may automatically shut off safety valves to stop the flame. The flame temperature sensor 367 measures the flame temperatures for the PLC 500 for both control and safety purposes. The PLC 500 can adjust the fuel-to-oxidizer ratio to control the flame temperature and control the fuel and oxidizer flow rates to control flame power. If the flame temperature exceeds a predetermined threshold, the PLC 500 may automatically shut off safety valves to stop the flame. The fuel flow rate sensor 532 measures actual flow rate of the fuel supplied to the torch apparatus 200 and may be integrated in the MFC 350 shown in each of FIGS. 3A, 3B, and 4. The compressed air flow rate sensor 534 measures actual flow rate of the compressed air supplied to the grit apparatus 100 and may be integrated in the MFC 310 shown in FIG. 3A. The oxidizer flow rate sensor 536 measures actual flow rate of the oxidizer supplied to torch apparatus 200 and may be integrated in the MFC 410 shown in FIG. 4.

In embodiments, the output devices 550 include the fuel MFC 350, the oxidizer MFC 410, the compressed air MFC 310, the ignitor 225, the fuel valve 352, the compressed air valve 312, the oxidizer valve 412, the grit valve 332 and the shield motion actuator 373. The fuel MFC 350 controls the flow rate of the fuel supply to the torch apparatus 200. The fuel MFC 350 is exemplarily controlled via a current or voltage analog signal to control the flow rate to a setpoint. A current flow rate of the fuel is measured by fuel flow rate sensor 532 and fed back to the PLC 500 via a separate current or voltage analog signal to monitor and record the actual fuel flow rate. The fuel MFC 350 allows a static setpoint or the PLC 500 can ramp the setpoint of the fuel MFC 350 according to a programmed rate. By controlling the fuel flow rate the fuel via the MFC 350, the PLC 500 may control the temperature of the flame 250 (shown in FIGS. 3A and 3B) or flame 420 (shown in FIG. 4) in real time and allow a dynamic testing temperature.

Similarly, the compressed air MFC 310 (shown in FIGS. 3A and 3B) and oxidizer MFC 410 (shown in FIG. 4) are exemplarily controlled via a current or voltage analog signal to control the flow rate to a set point. A current flow rate of the compressed air or oxidizer is measured by the compressed air flow rate sensor 534 or the oxidizer flow rate sensor 536, and fed back to the PLC 500 via a separate a current or voltage analog signal to monitor and record the actual compressed air or oxidizer flow rate. The compressed air MFC 310 or the oxidizer MFC 410 allows a static setpoint or the PLC 500 can ramp the setpoint of the compressed air MFC 310 or the oxidizer MFC 410 according to a programmed rate. By controlling the flow rate of the compressed air (via the MFC 310) or oxidizer (via the MFC 410), the PLC 500 may control the temperature of the flame 250 (shown in FIGS. 3A and 3B) or flame 420 (shown in FIG. 4) in real time and allow a dynamic testing temperature.

The ignitor 225 is controlled by the PLC 500 for igniting the mixture of fuel and oxidizer in the torch apparatus 200. In embodiments, the ignitor 225 may be a spark or glow plug ignitor. In operations, for safety, both the fuel MFC 350 and the oxidizer MFC 410 are set at 50% of the commanded setpoint by the PLC 500 before igniting. After the flame has been ignited, and presence of the flame is confirmed to the PLC 500 with a flame temperature sensor 367, the fuel MFC 350's and the oxidizer MFC 410's setpoints are set at 100% of the commanded setpoint. If a flame is not sensed, the torch-and-grit system 300 or 400 goes into shutdown mode, so that the user can troubleshoot.

The compressed air valve 312 and grit valve 332 for grit mass flow are controlled by the PLC 500. In embodiments, the duration of the timing of both the air valve 312 and the grit valve 332 is controlled on the HMI 570. The position of these valves 312 and 332 is fed back to an input of the PLC 500 to record the valve state.

The fuel valve 352, the compressed air valve 312 and the oxidizer valve 412 are controlled by the PLC 500 to provide safety shutdown in case of emergency. Each of these valves 352, 312 and 412 may also be integrated with an emergency stop (not shown) for manual shutdown in case of emergency.

The shield motion actuator 373 is also controlled by the PLC 500. As an example, the shield motion actuator 373 is implemented with a double acting pneumatic cylinder and solenoids controlled by the PLC 500. At a start of a test, the PLC 500 controls the shield motion actuator 373 to automatically retract out of the way between the torch apparatus 200 and the material sample 360, so that the material sample 360 can be exposed to the flame 250. After the test is completed, either the PLC 500 or the user through the HMI 570 can control the flame shield 370, via the shield motion actuator 373, back into the blocking position between the torch apparatus 200 and the material sample 360.

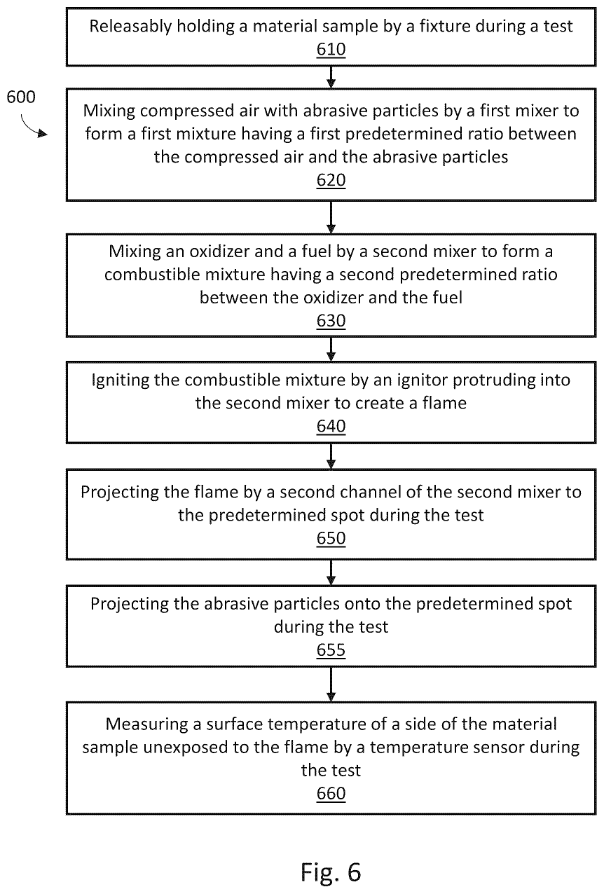

FIG. 6 is a flowchart illustrating an exemplary process 600 of testing a material sample under simulated conditions. The process 600 begins with releasably holding a material sample by a fixture during a test in block 610. The process 600 mixes compressed air with abrasive particles by a first mixer to form a first mixture having a first predetermined ratio between the compressed air and the abrasive particles in block 620. The process 600 channels the first mixture by a first channel of the first mixer to a predetermined spot of the material sample during the test in block 630. The process 600 mixes an oxidizer and a fuel by a second mixer to form a combustible mixture having a second predetermined ratio between the oxidizer and the fuel in block 630. The process 600 ignites the combustible mixture by an ignitor located adjacent to the outlet of or protruding into the second mixer to create a flame in block 640. The process 600 projects the flame by a second channel of the second mixer to the predetermined spot during the test in block 650. The process 600 projects the abrasive particles onto the predetermined spot during the test, including in embodiments where the abrasive particles are constantly projected onto the spot during a test or embodiments where the abrasive particles are projected onto the spot at predetermined intervals during the test for predetermined durations of time during the test. The process 600 measures a surface temperature of a side of the material sample unexposed to the flame by a temperature sensor during the test in block 660.

As described above, the torch-and-grit apparatus is a device used for evaluation, testing and comparison of material samples to a simulated lithium-ion battery thermal runaway event. The purpose of the apparatus is to develop material performance data for comparative selection of materials for end-product applications where resistance to lithium-ion battery thermal runaway is a concern. The device uses a burner, also called a torch, to create a flame from a mixture of a fuel such as hydrogen, methane or propane and an oxidizer such as air or oxygen. The device also uses compressed air and an abrasive particle metering mechanism to create a pressurized flow of abrasive particles, also called grit, directed to the same spot as the burner flame. These two systems in the device, the premixed flame system and the grit system, generate a standardized but also customizable thermomechanical exposure to a material sample plaque. The device is automated and controlled with a programmable logic controller.

At least some aspects of the present disclosure will now be described with reference to the following numbered clauses.
Clause 1. An apparatus for testing a material sample, the apparatus comprising: a fixture configured to releasably hold the material sample during a test; a first mixer having a first chamber and a first channel, the first chamber being configured to mix compressed air with abrasive particles to form a first mixture having a first predetermined ratio between the compressed air and the abrasive particles, the first channel being configured to project the first mixture at a predetermined spot of the material sample during the test; a second mixer having a second chamber, an ignitor and a second channel, the second chamber being configured to mix an oxidizer and a fuel to form a combustible mixture with a second predetermined ratio between the oxidizer and the fuel, the ignitor located adjacent to an outlet of or protruding into the second chamber and configured to controllably ignite the combustible mixture to create a flame, the second channel being configured to project the flame at the predetermined spot during the test; and a first temperature sensor configured to measure a surface temperature of a side of the material sample unexposed to the flame during the test.
Clause 2. The apparatus of clause 1, further comprising a second temperature sensor configured to measure a temperature of the flame before and/or during the test.
Clause 3. The apparatus of clause 2, further comprising a programmable logic controller configured to receive temperature measurements from the first and second temperature sensors and to control flow rates of the oxidizer and the fuel based at least in part on the temperature measurements.
Clause 4. The apparatus of clause 3, further comprising a first mass flow controller controlled by the programmable logic controller to control the flow rate of the compressed air supplied to the first mixer during the test.
Clause 5. The apparatus of clause 3, further comprising a second mass flow controller controlled by the programmable logic controller to control the flow rate of the fuel supplied to the second mixer during the test.
Clause 6. The apparatus of clause 3, further comprising a third mass flow controller controlled by the programmable logic controller to control a flow rate of the oxidizer supplied to the second mixer during the test.
Clause 7. The apparatus of clause 3, wherein the first chamber includes a narrow passage and port leading to the narrow passage.
Clause 8. The apparatus of clause 7, further comprising a container configured to hold a supply of the abrasive particles and controllably deliver the abrasive particles to the port due to gravity and/or negative pressure differential.
Clause 9. The apparatus of clause 8, further comprising an actuating pinch valve connected between the container and the port and controlled by the programmable logic controller for regulating an amount of abrasive particles flowed to the port during the test.
Clause 10. The apparatus of clause 3, further comprising a third temperature sensor configured to measure an ambient temperature behind the material sample unexposed to the flame, wherein the ambient temperature is provided to the programmable logic controller.
Clause 11. The apparatus of clause 3, further comprising a heat shield motioned between a first position shielding the material sample from the flame and a second position exposing the material sample to the flame, wherein the motion of the heat shield is controlled by the programmable logic controller.
Clause 12. The apparatus of clause 3, wherein the programmable logic controller is programmed to actuate the ignitor at a predetermined flow rate setpoint for the fuel.
Clause 13. The apparatus of clause 1, wherein the first channel leads to or towards the second chamber to provide the first mixture to the second mixer.
Clause 14. The apparatus of clause 1, further comprising a flame arrestor horizontally placed above the material sample to prevent the flame from reaching a space behind the material sample.
Clause 15. A system for testing a material sample, the system comprising: a fixture configured to releasably hold the material sample during a test; a first mixer having a first chamber and a first channel, the first chamber being configured to mix compressed air with abrasive particles to form a first mixture having a first predetermined ratio between the compressed air and the abrasive particles, the first channel being configured to project the first mixture at a predetermined spot of the material sample during the test; a second mixer having a second chamber, an ignitor and a second channel, the second chamber being configured to mix an oxidizer and a fuel to form a combustible mixture with a second predetermined ratio between the oxidizer and the fuel, the ignitor located adjacent to an outlet of or protruding into the second chamber and configured to controllably ignite the combustible mixture to create a flame, the second channel being configured to project the flame at the predetermined spot during the test; a first temperature sensor configured to measure a surface temperature of a side of the material sample unexposed to the flame during the test; a second temperature sensor configured to measure a temperature of the flame before and/or during the test; and a programmable logic controller configured to receive temperature measurements from the first and second temperature sensors and to regulate flow rates of the oxidizer and the fuel based at least in part on the temperature measurements.
Clause 16. The system of clause 15, further comprising a first mass flow controller controlled by the programmable logic controller to control the flow rate of the compressed air supplied to the first mixer during the test.
Clause 17. The system of clause 15, further comprising a second mass flow controller controlled by the programmable logic controller to control the flow rate of the fuel supplied to the second mixer during the test.
Clause 18. The system of clause 15, further comprising a third mass flow controller controlled by the programmable logic controller to control a flow rate of the oxidizer supplied to the second mixer during the test.
Clause 19. The system of clause 15, wherein the first channel leads to or towards the second chamber to provide the first mixture to the second mixer.
Clause 20. A method for testing a material sample, the method comprising: releasably holding the material sample by a fixture during a test; mixing compressed air with abrasive particles by a first mixer to form a first mixture having a first predetermined ratio between the compressed air and the abrasive particles; channeling the first mixture by a first channel of the first mixer to a predetermined spot of the material sample during the test; mixing an oxidizer and a fuel by a second mixer to form a combustible mixture having a second predetermined ratio between the oxidizer and the fuel; igniting the combustible mixture by an ignitor adjacent to an outlet of or protruding into the second mixer to create a flame; projecting the flame by a second channel of the second mixer to the predetermined spot during the test; and measuring a surface temperature of a side of the material sample unexposed to the flame by a temperature sensor during the test.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

We claim:

1. An apparatus for testing a material sample, the apparatus comprising:
a fixture configured to releasably hold the material sample during a test;
a first mixer having a first chamber and a first channel, the first chamber being configured to mix compressed air with abrasive particles to form a first mixture having a first predetermined ratio between the compressed air and the abrasive particles, the first channel being configured to project the first mixture at a predetermined spot of the material sample during the test;
a second mixer having a second chamber, an ignitor and a second channel, the second chamber being configured to mix an oxidizer and a fuel to form a combustible mixture with a second predetermined ratio between the oxidizer and the fuel, the ignitor located adjacent to an outlet of or protruding into the second chamber and configured to controllably ignite the combustible mixture to create a flame, the second channel being configured to project the flame at the predetermined spot during the test; and
a first temperature sensor configured to measure a surface temperature of a side of the material sample unexposed to the flame during the test.

2. The apparatus of claim 1, further comprising a second temperature sensor configured to measure a temperature of the flame before and/or during the test.

3. The apparatus of claim 2, further comprising a programmable logic controller configured to receive temperature measurements from the first and second temperature sensors and to control flow rates of the oxidizer and the fuel based at least in part on the temperature measurements.

4. The apparatus of claim 3, further comprising a first mass flow controller controlled by the programmable logic controller to control the flow rate of the compressed air supplied to the first mixer during the test.

5. The apparatus of claim 3, further comprising a second mass flow controller controlled by the programmable logic controller to control the flow rate of the fuel supplied to the second mixer during the test.

6. The apparatus of claim 3, further comprising a third mass flow controller controlled by the programmable logic controller to control a flow rate of the oxidizer supplied to the second mixer during the test.

7. The apparatus of claim 3, wherein the first chamber includes a narrow passage and port leading to the narrow passage.

8. The apparatus of claim 7, further comprising a container configured to hold a supply of the abrasive particles and controllably deliver the abrasive particles to the port due to gravity and/or negative pressure differential.

9. The apparatus of claim 8, further comprising an actuating pinch valve connected between the container and the port and controlled by the programmable logic controller for regulating an amount of abrasive particles flowed to the port during the test.

10. The apparatus of claim 3, further comprising a third temperature sensor configured to measure an ambient temperature behind the material sample unexposed to the flame, wherein the ambient temperature is provided to the programmable logic controller.

11. The apparatus of claim 3, further comprising a heat shield motioned between a first position shielding the material sample from the flame and a second position exposing the material sample to the flame, wherein the motion of the heat shield is controlled by the programmable logic controller.

12. The apparatus of claim 3, wherein the programmable logic controller is programmed to actuate the ignitor at predetermined flow rate setpoint for the fuel.

13. The apparatus of claim 1, wherein the first channel leads to or towards the second chamber to provide the first mixture to the second mixer.

14. The apparatus of claim 1, further comprising a flame arrestor horizontally placed above the material sample to prevent the flame from reaching a space behind the material sample.

15. A system for testing a material sample, the system comprising:
a fixture configured to releasably hold the material sample during a test;
a first mixer having a first chamber and a first channel, the first chamber being configured to mix compressed air with abrasive particles to form a first mixture having a first predetermined ratio between the compressed air and the abrasive particles, the first channel being configured to project the first mixture at a predetermined spot of the material sample during the test;
a second mixer having a second chamber, an ignitor and a second channel, the second chamber being configured to mix an oxidizer and a fuel to form a combustible mixture with a second predetermined ratio between the oxidizer and the fuel, the ignitor located adjacent to an outlet of or protruding into the second chamber and configured to controllably ignite the combustible mixture to create a flame, the second channel being configured to project the flame at the predetermined spot during the test;
a first temperature sensor configured to measure a surface temperature of a side of the material sample unexposed to the flame during the test;
a second temperature sensor configured to measure a temperature of the flame before and/or during the test; and
a programmable logic controller configured to receive temperature measurements from the first and second temperature sensors and to regulate flow rates of the oxidizer and the fuel based at least in part on the temperature measurements.

16. The system of claim 15, further comprising a first mass flow controller controlled by the programmable logic controller to control the flow rate of the compressed air supplied to the first mixer during the test.

17. The system of claim 15, further comprising a second mass flow controller controlled by the programmable logic controller to control the flow rate of the fuel supplied to the second mixer during the test.

18. The system of claim 15, further comprising a third mass flow controller controlled by the programmable logic controller to control a flow rate of the oxidizer supplied to the second mixer during the test.

19. The system of claim 15, wherein the first channel leads to or towards the second chamber to provide the first mixture to the second mixer.

20. A method for testing a material sample, the method comprising:
releasably holding the material sample by a fixture during a test;
mixing compressed air with abrasive particles by a first mixer to form a first mixture having a first predetermined ratio between the compressed air and the abrasive particles;
channeling the first mixture by a first channel of the first mixer to a predetermined spot of the material sample during the test;
mixing an oxidizer and a fuel by a second mixer to form a combustible mixture having a second predetermined ratio between the oxidizer and the fuel;
igniting the combustible mixture by an ignitor located adjacent to an outlet of or protruding into the second mixer to create a flame;
projecting the flame by a second channel of the second mixer to the predetermined spot during the test; and
measuring a surface temperature of a side of the material sample unexposed to the flame by a temperature sensor during the test.
